(19) United States
(12) Patent Application Publication
(10) Pub. No.: US 2008/0045737 A1
(43) Pub. Date: Feb. 21, 2008

(54) Continuous Preparation of Organosilanes

(75) Inventors: Gilbert Geisberger, Altoetting (DE); Marco Auer, Hamburg (DE); Armin Groessmann, Mehring-Oed (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/841,092

(22) Filed: Aug. 20, 2007

(30) Foreign Application Priority Data
Aug. 21, 2006 (DE) 10 2006 039 191.8

(51) Int. Cl. C07F 7/08

(52) U.S. Cl. 556/478

(57) ABSTRACT

The invention relates to a process for the continuous preparation of organosilanes in a reactive distillation column, wherein a homogenous hydrosilylation catalyst is introduced into the column.

### BACKGROUND OF THE INVENTION

1. Field of the Invention

The invention relates to a process for the continuous preparation of organosilanes in a reactive distillation column.

2. Background Art

Functionalized organosilanes are of great economic importance, in particular halogen-substituted organosilanes, since such silanes serve as starting materials for the preparation of many important products, for example silicones, bonding agents, hydrophobicizing agents and building protection agents.

The preparation of organosilicon compounds may be carried out, for example, by means of a hydrosilylation reaction, where an Si—H functionality is added onto alkenes in the presence of catalysts. A distinction may be made between homogeneous and heterogeneous hydrosilylation. In homogeneous hydrosilylation, soluble catalysts are used, while in the case of heterogeneous hydrosilylation, elemental platinum or supported catalysts are used. An important problem is the formation of by-products which leads, for example, to halosilanes and alkenes and thus results in a reduced yield of product.

Published patent application EP 0 823 434 A1 describes a continuous process for preparing 3-halopropyl organosilanes in which the formation of by-products is said to be suppressed by carrying out the reaction with only a partial conversion of the starting materials. The by-product propene is separated off simultaneously in the reactor or subsequently by means of at least one separation step. A disadvantage of this process is the higher costs of the process which is associated with recirculation of unreacted starting materials.

Published patent application DE 34 04 703 A1 describes a process for preparing 3-chloropropyltrichlorosilane using a specific platinum-containing heterogeneous catalyst having a high selectivity, with simultaneous removal of propene. The disadvantage of this process is the very complicated and thus expensive preparation of the heterogeneous catalyst.

Patent applications DE 100 53 037 C1 and DE 102 32 663 C1 describe processes which are based on specific iridium catalysts using a diene as cocatalyst. A disadvantage here is that, owing to the relatively low catalytic activity, a correspondingly high noble metal concentration is necessary.

Published patent application DE 101 53 795 A1 describes a process employing a reactive distillation column using heterogeneous platinum catalysts. Disadvantages are the known problems associated with heterogeneous catalysis, e.g. lower conversion as the catalyst activity decreases. In addition, when the activity becomes too low, it is necessary to replace the catalyst, which is associated with plant downtime and lost production.

### SUMMARY OF THE INVENTION

It was therefore an object of the invention to make available an improved continuous process which makes constant high conversions into organosilanes possible. These and other objects are achieved through the use of homogenous hydrosilylation catalysts in a reactive distillation column.

### BRIEF DESCRIPTION OF THE DRAWINGS

FIG. 1 illustrates schematically one embodiment of a process of the present invention.

### DETAILED DESCRIPTION OF THE PREFERRED EMBODIMENT(S)

The invention thus provides a process for the continuous preparation of silanes of the general formula (I)

R⁶R⁵CH—R⁴CH—SiR¹R²R³ (I),

in which a silane of the general formula (II)

HSiR¹R²R³ (II),

is reacted with an alkene of the general formula (III)

R⁶R⁵CH═CHR⁴ (III),

where
R¹, R², R³ are each a monovalent Si—C-bonded, unsubstituted or halogen-substituted C₁-C₁₈ hydrocarbon radical, chlorine radical or C₁-C₁₈ alkoxy radical,
R⁴, R⁵, R⁶ are each a hydrogen atom, a monovalent unsubstituted or F—, Cl—, OR—, NR₂—, CN— or NCO-substituted C₁-C₁₈ hydrocarbon radical, chlorine radical, fluorine radical or C₁-C₁₈ alkoxy radical, where 2 radicals from among R⁴, R⁵, R⁶ together with the carbon atoms to which they are bound may form a cyclic radical,
R is a hydrogen atom or a monovalent C₁-C₁₈ hydrocarbon radical,
   in the presence of at least one homogeneous noble metal catalyst, wherein the reaction is carried out in a reactive distillation column.

The continuous process gives the silane of the general formula (I) in high yields and excellent purity. Contrary to the prior art, for example as disclosed in: REACTIVE DISTILLATION, STATUS AND FUTURE DIRECTIONS, Kai Sundmacher and Achim Kienle, Wiley-VHC, 2002, ISBN 3527305793, page 187, section 7.5, the process of the invention displays significant advantages over heterogeneous catalysis, in which it is hardly possible to meet the contradictory demands on catalyst residence time, pressure drops and good vapor-liquid contact. In the process of the invention, it is possible, as a result of the use of homogeneous catalysis, to vary both the amount and point of addition of the catalyst. The process is therefore significantly easier to control and monitor and can be carried out significantly more reliably. The yields can also be increased significantly by recirculation of the alkene of the general formula (III). Industrial apparatuses for carrying out the process include any distillation columns suitable for a continuous reaction.

C₁-C₁₈-Hydrocarbon radicals R¹, R², R³ are preferably alkyl, alkenyl, cycloalkyl or aryl radicals. R¹, R², R³ preferably have not more than 10, in particular not more than 6, carbon atoms. R¹, R², R³ are preferably straight-chain or branched C₁-C₆-alkyl radicals or C₁-C₆-alkoxy radicals. Preferred halogen substituents are fluorine and chlorine. Particularly preferred radicals R¹, R², R³ are the radicals methyl, ethyl, methoxy, ethoxy, chlorine, phenyl and vinyl.

R⁴, R⁵, R⁶ are each a hydrogen atom, a monovalent unsubstituted or F—, Cl—, OR—, NR₂—, CN— or NCO-substituted C₁-C₁₈-hydrocarbon radical, chlorine radical, fluorine radical or C₁-C₁₈-alkoxy radical, where 2 radicals from among R⁴, R⁵, or R⁶, together with the carbon atoms to which they are bound, may form a cyclic radical. R⁵ and R⁶ preferably have not more than 10, in particular not more than 6 carbon atoms. R⁵ and R⁶ preferably have not more than 10, in particular not more than 6 carbon atoms. R⁵ and R⁶ are preferably straight-chain or branched C₁-C₆-alkyl radicals or C₁-C₆-alkoxy radicals. Particularly preferred radicals R⁵ and R⁶ are the radicals hydrogen, methyl, ethyl, chloromethyl, chlorine and phenyl.

Hydrocarbon radical R⁴ preferably has not more than 6, in particular not more than 2 carbon atoms. Particularly preferred radicals R⁴ are the radicals hydrogen, methyl, ethyl. Hydrocarbon radical R also preferably has not more than 6, in particular not more than 2 carbon atoms.

As alkene(s) of the general formula (III), preference is given to using allyl chloride.

The alkene of the general formula (III) can be used either in a superstoichiometric amount or in a substoichiometric amount relative to the silane component (II). The molar ratio of the alkene (III) to silane (II) is preferably in the range from 0.1 to 20, more preferably from 0.8 to 1.5.

The process of the invention can be carried out using any homogeneous catalyst useful for the addition of Si-bonded hydrogen onto aliphatically unsaturated compounds. Examples of such catalysts are compounds or complexes of the group of noble metals consisting of platinum, ruthenium, iridium, rhodium and palladium, for example platinum halides, platinum-olefin complexes, platinum-alcohol complexes, platinum-alkoxide complexes, platinum-ether complexes, platinum-aldehyde complexes, platinum-ketone complexes, including reaction products of H₂PtCl₆.6H₂O and cyclohexanone, platinum-vinylsiloxane complexes, in particular platinum-divinyltetramethyldisiloxane complexes with or without a content of detectable inorganically bound halogen, bis(γ-picoline)platinum dichloride, trimethylenedipyridineplatinum dichloride, dicyclopentadieneplatinum dichloride, (dimethyl sulfoxide)ethyleneplatinum(II) dichloride and reaction products of platinum tetrachloride with olefin and a primary amine or secondary amine or both primary and secondary amine, for example the reaction product of platinum tetrachloride dissolved in 1-octene with sec-butylamine. In a further preferred embodiment of the process of the invention, complexes of iridium with cyclooctadienes, for example μ-dichlorobis(cyclooctadiene)diiridium(I), may be used.

The catalyst preferably comprises compounds or complexes of platinum or iridium, more preferably platinum, yet more preferably platinum chlorides and platinum complexes, in particular platinum-olefin complexes, and with particular preference, platinum-divinyltetramethyldisiloxane complexes. In a further embodiment, cocatalysts can aid the reaction.

In the process of the invention, the catalyst is used in amounts of from 1 to 1000 ppm by weight, calculated as elemental noble metal and based on the total weight of the components (II) and (III) present in reaction mixtures. Preference is given to using from 2 to 150 ppm by weight, more preferably from 5 to 50 ppm by weight.

In the process of the invention the amount of active catalyst is kept at the desired level by continuous addition of fresh catalyst and simultaneous removal of exhausted catalyst. This prevents a decrease in activity in the reaction and thus downtime of the plant for replacement of catalyst.

The critical advantage of the process of the invention is the continuous introduction of the catalyst into the reactive distillation column. In the process of the invention, a broadened influence on reaction and operating conditions can be exerted by means of the additional regulating parameter of catalyst addition. The process can be controlled better by means of the type, point of addition and amount of catalyst. This leads, for example, to separation effectiveness of the column, avoidance of hotspots (secondary reactions, thermal catalyst decomposition), fluctuations in catalyst activity between different batches are avoided, and the reaction can be stopped quickly by switching off the addition of catalyst (emergency shutdown). Furthermore, the process of the invention allows a simplified start up of the reactive distillation since the catalyst is added only after the necessary column profile has been reached. Product changes are also simplified in a column since flushing of the plant is sufficient for the change of catalyst and disassembly of the plant is no longer necessary. By “continuous” is also meant a discontinuous but oft-repeated addition which simulates continuous addition.

The process can be carried out in the presence or absence of aprotic solvents. If aprotic solvents are used, solvents or solvent mixtures having a boiling point or boiling range up to 120° C. at 0.1 MPa are preferred. Examples of such solvents are ethers such as dioxane, tetrahydrofuran, diethyl ether, diisopropyl ether, diethylene glycol dimethyl ether; chlorinated hydrocarbons such as dichloromethane, trichloromethane, tetrachloromethane, 1,2-dichloroethane, trichloroethylene; hydrocarbons such as pentane, n-hexane, hexane isomer mixtures, heptane, octane, naphtha, petroleum ether, benzene, toluene, xylenes; ketones such as acetone, methyl ethyl ketone, diisopropyl ketone, methyl isobutyl ketone (MIBK); esters such as ethyl acetate, butyl acetate, propyl propionate, ethyl butyrate, ethyl isobutyrate; carbon disulfide and nitrobenzene, or mixtures of these solvents. The target product of the general formula (I) can also be used as aprotic solvent in the process. This process variant is preferred.

The noble metal catalysts are preferably dissolved in solvents, most preferably in ionic liquids. This makes it possible for part or even all of the catalyst to be added in feed streams. When ionic liquids are used, the particularly preferred solvent is an ionic liquid of the general formula (IV).

In a preferred embodiment of the process of the present invention, the ionic liquid used is an ionic liquid of the general formula (IV)

[A]⁺[Y]⁻ (IV)

where
[Y]— is an anion selected from the group consisting of [tetrakis(3,5-bis(trifluoromethyl)phenyl)borate]([BARF]), tetrafluoroborate ([BF₄]⁻), hexafluorophosphate ([PF₆]⁻), trispentafluoroethyltrifluorophosphate ([P(C₂F₅)₃F₃]—), hexafluoroantimonate ([SbF₆]⁻), hexafluoroarsenate ([AsF₆]⁻), fluorosulfonate, [R′—COO]⁻, [R′—SO₃]⁻, [R′—O—SO₃]⁻, [R′₂—PO₄]⁻ and [(R′—SO₂)₂N]⁻, where R′ is a linear or branched aliphatic or alicyclic alkyl radical having from 1 to 12 carbon atoms, a C₅-C₁₈-aryl radical or a C₅-C₁₈-aryl-C₁-C₆-alkyl radical whose hydrogen atoms may have been completely or partly replaced by fluorine atoms, and
[A]⁺ is a cation selected from the group consisting of ammonium cations of the general formula (V)

[NR⁷R⁸R⁹R¹⁰]⁺ (V),

phosphonium cations of the general formula (VI)

[PR⁷R⁸R⁹R¹⁰]⁺ (VI),

imidazolium cations of the general formula (VII)

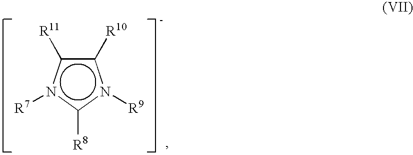

pyridinium cations of the general formula (VIII)

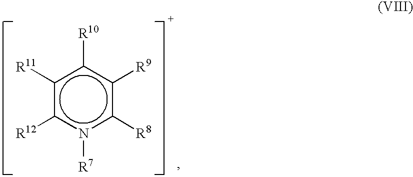

pyrazolium cations of the general formula (IX)

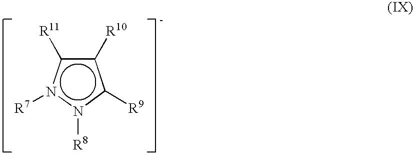

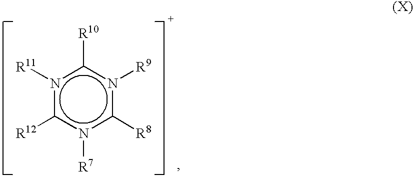

picolinium cations of the general formula (XI)

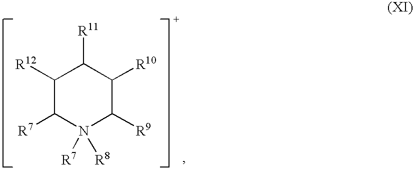

and
pyrrolidinium cations of the general formula (XII)

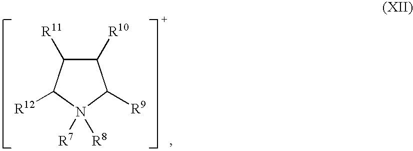

where the radicals R⁷⁻¹² are, independently of one another, organic radicals having 1-20 carbon atoms, more preferably aliphatic, cycloaliphatic, aromatic, araliphatic or oligoether groups. Suitable aliphatic groups are straight-chain or branched hydrocarbon radicals which have from one to twenty carbon atoms and in which heteroatoms such as oxygen, nitrogen or sulfur atoms can be present in the chain. The radicals R⁷⁻¹² can be saturated or have one or more double or triple bonds which can be conjugated or be present in isolated positions in the chain.

Examples of aliphatic groups are hydrocarbon groups having from one to 14 carbon atoms, for example methyl, ethyl, n-propyl, isopropyl, n-butyl, sec-butyl, tert-butyl, n-pentyl, n-hexyl, n-octyl or n-decyl.

Examples of cycloaliphatic groups are cyclic hydrocarbon radicals which have from three to twenty carbon atoms and may contain ring heteroatoms, for example oxygen, nitrogen or sulfur atoms. The cycloaliphatic groups can also be saturated or have one or more double or triple bonds which can be conjugated or be present in isolated positions in the ring. Saturated cycloaliphatic groups, in particular saturated aliphatic hydrocarbons, which have from five to eight ring carbons, preferably five or six ring carbons, are preferred.

Aromatic groups, carbocyclic aromatic groups or heterocyclic aromatic groups can have from six to twenty-two carbon atoms. Examples of suitable aromatic groups are phenyl, naphthyl and anthryl.

Oligoether groups are groups of the general formula (XIII)

—[(CH₂)ₓ—O]_{y}—R′″ (XIII),

where
x and y are, independently of one another, from 1 to 250 and R′″ is an aliphatic, cycloaliphatic, aromatic or araliphatic group.

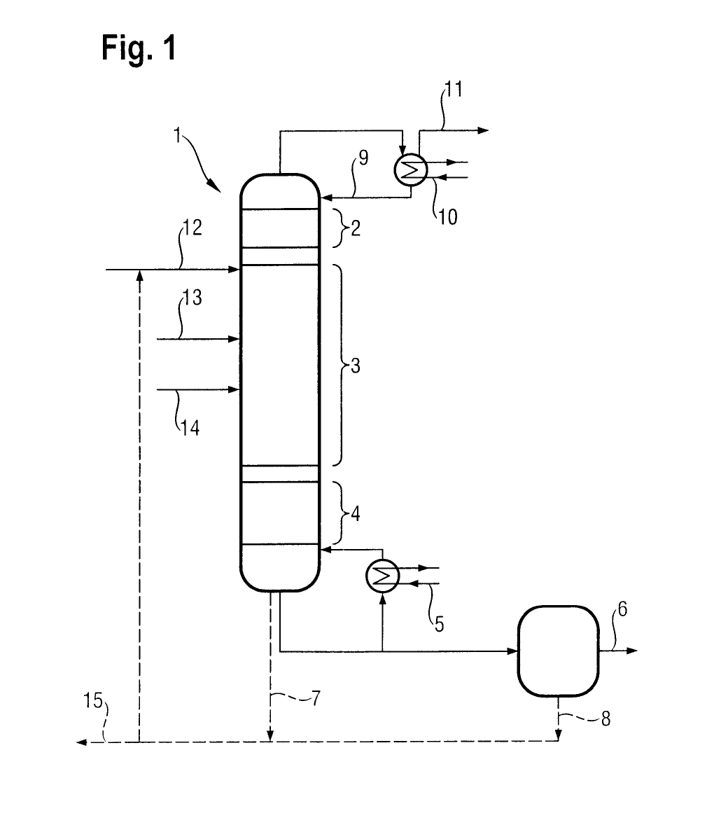

The process of the invention in a reaction distillation column is shown schematically in the drawing of FIG. 1.

Here, the numbers in FIG. 1 have the following meanings:
1: reaction distillation column
2: separation zone
3: reaction zone
4: separation zone
5: vapor
6: product
7: variant of catalyst removal
8: variant of catalyst removal
9: alkene recirculation
10: cooling water
11: low boilers
12: catalyst solution
13: alkene of the formula (III)
14: silane of the formula (II)
15: catalyst work up

The alkene 13 of the formula (III) and silane 14 of the formula (II) are used as starting materials. To start up the reactive distillation, alkene 13 and product 6 are placed in the column in the first step and the column profile is established with total reflux and without a bottom stream being taken off. In the 2nd step, the catalyst solution 12, the alkene 13 and the silane 14 are metered in. The amount of silane 14 is then slowly increased. The target product 6 and the by-products are formed and are taken off together as high boilers at the bottom. Process control is effected, for example if the catalyst activity becomes too low, by increased addition of catalyst solution 12. In the case of malfunctions, the introduction of catalyst can be stopped immediately and the reaction stopped as a result. An excess of alkene 13 led to an improvement in the selectivity to the target product. The removal of the catalyst can be effected according to two variants. In variant 7, the removal is effected directly at the bottom of the column when the catalyst solution forms a second phase, for example when ionic liquids are used. In variant 8, the removal is effected in a downstream apparatus, for example in a thin film evaporator or a phase separator. The catalyst solution which has been separated off can, if the catalyst activity is sufficient, be recirculated to the reaction column or is passed to another work-up 15. The reuse of catalyst is a further advantage of the process of the invention.

In a particularly preferred process, the noble metal catalyst or its solution is separated off from the silane mixture in an apparatus located downstream of the reactive distillation column or in the column, for example by means of a phase separator, and recirculated to the reactive distillation column or separated off for renewed work-up and preparation of fresh catalyst.

The process is preferably carried out at a reaction temperature of 0-200° C., more preferably from 20 to 120° C., and preferably at a reaction pressure of 0.5-150 bar, more preferably 1-20 bar.

### EXAMPLES

In the following, the abbreviations have the following meanings:
AC allyl chloride
BTA bistrifluoromethanesulfonylimide
GF12 (3-chloropropyl)methyldichlorosilane
GF15 (3-chloropropyl)trichlorosilane
HM methyldichlorsilane
CAT-SOL catalyst solution
M1 methyltrichlorosilane
Pro propyltrichlorosilane
ProMe propylmethyldichlorosilane
EMIM 1-ethyl-2,3-dimethylimidazolium
Sitri trichlorosilane
Temp temperature
Tetra tetrachlorosilane

### Example 1

FIG. 1 shows the flow diagram of the reactive distillation which is operated at the column profile shown in table 1. A solution of PtCl₄ in 1-dodecene (Pt content 0.1% by weight) was used as CAT-SOL 12. The Pt concentration in the column was 5 ppm by weight. Sitri 14 and AC 13 were used as starting materials. To start up the reactive distillation, AC 13 and GF 15 were placed in the column in the first step and the column profile was established at total reflux and without taking off a bottom stream. In the 2nd step, the catalyst solution 12, AC 13 and Sitri 14 were metered in. The amount of Sitri 14 was then slowly increased. GF15 as target product 6 and the by-products Pro and Tetra were formed and were taken off together as high boilers from the bottom of plate 14. Process control was effected, for example, when the catalyst activity became too low, by further introduction of catalyst solution 12. In the case of malfunctions, the introduction of catalyst can be stopped immediately and the reaction thus stopped. An excess of AC 13 led to an improvement in the selectivity to the target product 6 GF15. The catalyst was removed according to variant 8. Catalyst recirculation was not carried out but the catalyst was instead passed to a work-up 15.

### Example 2

This example was carried out in a manner analogous to example 1. The difference lies in the immobilization of the Pt catalyst in the ionic liquid [EMIM][BTA]. As CAT-SOL, 500 ppm by weight of Pt based on the total feed as PtCl₄ were dissolved in the ionic liquid. The ionic liquid forms a second liquid phase at the bottom of the column or in a downstream apparatus. This makes it possible to recirculate the catalyst to the reactive distillation, which represents a significant advantage of this method. FIG. 1 shows the flow diagram of this reactive distillation, with recirculation of catalyst both according to variant 7 and according to 8 being successful.

### Example 3

FIG. 1 shows the flow diagram of the reactive distillation which is operated at the column profile shown in table 2. A solution of [(COD)IrCl]₂ in chlorobenzene (Ir concentration: 1.1% by weight) was used as CAT SOL 12. The Ir concentration in the column was 50 ppm by weight of Ir. HM and AC were used as starting materials 14 and 13. To start up the reactive distillation, AC and GF12 were placed in the column in the first step and the column profile was established at total reflux and without taking off a bottom stream. In the 2nd step, the catalyst solution 12, AC 13 and HM 14 were metered in. The amount of HM 14 was then slowly increased. GF12 as target product 6 and the by-products ProMe and Ml were formed and were taken off together as high boilers from the bottom of plate 14. Process control was effected, for example, when the catalyst activity became too low, by further introduction of catalyst solution 12. In the case of malfunctions, the introduction of catalyst can be stopped immediately and the reaction thus stopped. An excess of AC 13 led to an improvement in the selectivity to the target product 6 GF12. The catalyst was removed according to variant 8 with subsequent work-up 15. Recirculation of catalyst was not carried out.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

TABLE 1

| | | | Heat | | | | | | | | |
|---|---|---|---|---|---|---|---|---|---|---|---|
| | Temp. | Pressure | input | Composition of liquid [mol %] | | | | | | | |
| Plate | [° C.] | [bar abs] | [kW] | SITRI | CAT-SOL | TETRA | GF15 | PRO | AC | AC:Sitri | Inflows and outflows |
| 1 | 76.01 | 2.50 | −74.01 | 0.0021 | 0.0000 | 0.0552 | 0.0000 | 0.0000 | 0.9427 | 447.0 | Stream taken off: |
| condenser | | | | | | | | | | | low boilers, 0.5 kg/h |
| 2 | 76.30 | 2.50 | 0.00 | 0.0014 | 0.0000 | 0.0764 | 0.0000 | 0.0001 | 0.9222 | 679.7 | |
| 3 | 76.80 | 2.51 | 0.00 | 0.0009 | 0.0000 | 0.1042 | 0.0029 | 0.0009 | 0.8911 | 1039.6 | |
| 4 | 77.71 | 2.51 | 0.00 | 0.0029 | 0.0017 | 0.1376 | 0.0124 | 0.0038 | 0.8417 | 293.9 | Feed: Cat-Sol, |
| | | | | | | | | | | | 2.5 kg/h |
| 5 | 79.46 | 2.51 | 0.00 | 0.0112 | 0.0016 | 0.1691 | 0.0415 | 0.0134 | 0.7633 | 68.2 | Feed: AC, 175 kg/h |
| 6 | 87.50 | 2.51 | 0.00 | 0.0387 | 0.0028 | 0.2027 | 0.1830 | 0.0502 | 0.5226 | 13.5 | |
| 7 | 101.74 | 2.52 | 0.00 | 0.1266 | 0.0041 | 0.1516 | 0.4213 | 0.0929 | 0.2034 | 1.6 | Feed: Sitri, 330 kg/h |
| 8 | 124.44 | 2.52 | 0.00 | 0.0437 | 0.0051 | 0.1412 | 0.5698 | 0.1180 | 0.1223 | 2.8 | |
| 9 | 135.65 | 2.52 | 0.00 | 0.0168 | 0.0054 | 0.1381 | 0.6192 | 0.1261 | 0.0945 | 5.6 | |
| 10 | 140.48 | 2.52 | 0.00 | 0.0069 | 0.0055 | 0.1374 | 0.6369 | 0.1290 | 0.0843 | 12.2 | |
| 11 | 142.55 | 2.53 | 0.00 | 0.0029 | 0.0055 | 0.1373 | 0.6438 | 0.1302 | 0.0803 | 27.8 | |
| 12 | 143.44 | 2.53 | 0.00 | 0.0012 | 0.0055 | 0.1373 | 0.6466 | 0.1306 | 0.0787 | 64.3 | |
| 13 | 143.87 | 2.53 | 0.00 | 0.0005 | 0.0055 | 0.1373 | 0.6478 | 0.1309 | 0.0779 | 146.0 | |
| 14 | 145.88 | 2.53 | 0.66 | 0.0005 | 0.0056 | 0.1314 | 0.6576 | 0.1315 | 0.0733 | 151.1 | Stream taken off: |
| vaporizer | | | | | | | | | | | high boilers, 507 kg/h |

TABLE 2

| | | | Heat | | | | | | | | |
|---|---|---|---|---|---|---|---|---|---|---|---|
| | Temp. | Pressure | input | Composition of liquid [mol %] | | | | | | | |
| Plate | [° C.] | [bar abs] | [kW] | SITRI | CAT-SOL | TETRA | GF15 | PRO | AC | AC:Sitri | Inflows and outflows |
| 1 | 67.42 | 2.50 | −70.45 | 0.0000 | 0.0000 | 0.0028 | 0.0000 | 0.0000 | 0.9972 | 20 837.4 | Stream taken off: |
| condenser | | | | | | | | | | | low boilers, 0.5 kg/h |
| 2 | 67.51 | 2.00 | 0.00 | 0.0000 | 0.0000 | 0.0054 | 0.0000 | 0.0000 | 0.9946 | 23 317.2 | |
| 3 | 67.65 | 2.00 | 0.00 | 0.0000 | 0.0002 | 0.0103 | 0.0003 | 0.0000 | 0.9892 | 26 060.4 | |
| 4 | 68.03 | 2.01 | 0.00 | 0.0003 | 0.0026 | 0.0194 | 0.0030 | 0.0003 | 0.9744 | 3034.2 | Feed: Cat-Sol, |
| | | | | | | | | | | | 2.5 kg/h |
| 5 | 69.02 | 2.01 | 0.00 | 0.0029 | 0.0022 | 0.0354 | 0.0206 | 0.0018 | 0.9370 | 321.9 | Feed: AC, 220 kg/h |
| 6 | 76.89 | 2.01 | 0.00 | 0.0216 | 0.0043 | 0.0660 | 0.1838 | 0.0120 | 0.7123 | 33.1 | |
| 7 | 103.25 | 2.02 | 0.00 | 0.1024 | 0.0059 | 0.0577 | 0.5600 | 0.0255 | 0.2485 | 2.4 | Feed: Sitri, 330 kg/h |
| 8 | 127.04 | 2.02 | 0.00 | 0.0256 | 0.0067 | 0.0610 | 0.7137 | 0.0312 | 0.1618 | 6.3 | |
| 9 | 134.63 | 2.02 | 0.00 | 0.0062 | 0.0068 | 0.0643 | 0.7453 | 0.0326 | 0.1448 | 23.4 | |
| 10 | 136.69 | 2.02 | 0.00 | 0.0015 | 0.0069 | 0.0673 | 0.7519 | 0.0330 | 0.1395 | 93.8 | |
| 11 | 137.60 | 2.03 | 0.00 | 0.0004 | 0.0069 | 0.0717 | 0.7532 | 0.0334 | 0.1344 | 369.8 | |
| 12 | 139.37 | 2.03 | 0.00 | 0.0001 | 0.0072 | 0.0773 | 0.7566 | 0.0350 | 0.1239 | 1316.9 | |
| 13 | 147.30 | 2.03 | 0.00 | 0.0000 | 0.0080 | 0.0741 | 0.7836 | 0.0391 | 0.0951 | 3263.3 | |
| 14 | 175.15 | 2.03 | 11.92 | 0.0000 | 0.0074 | 0.0391 | 0.8799 | 0.0346 | 0.0390 | 3700.1 | Stream taken off: |
| vaporizer | | | | | | | | | | | high boilers, 552 kg/h |

What is claimed is:

1. A process for the continuous preparation of silane(s) of the formula (I)
R⁶R⁵CH—R⁴CH—SiR¹R²R³ (I),
comprising reacting at least one silane of the formula (II)
HSiR¹R²R³ (II),
with at least one alkene of the formula (III)
R⁶R⁵CH═CHR⁴ (III),
where
R¹, R², R³ are each individually a monovalent Si—C-bonded, unsubstituted or halogen-substituted C₁-C₁₈ hydrocarbon radical, a chlorine radical, or a C₁-C₁₈-alkoxy radical,
R⁴, R⁵, R⁶ are each individually a hydrogen atom, a monovalent unsubstituted or F—, Cl—, OR—, NR⁻₂, CN— or NCO-substituted C₁-C₁₈-hydrocarbon radical, chlorine radical, fluorine radical or C₁-C₁₈-alkoxy radical, where 2 radicals from among R⁴, R⁵, R⁶ together with the carbon atoms to which they are bound optionally form a cyclic radical,
R each individually is a hydrogen atom or a monovalent C₁-C₁₈ hydrocarbon radical,
said reacting taking place in the presence of at least one homogeneous noble metal catalyst, wherein the reaction is carried out in a reactive distillation column with continuous introduction of the homogeneous noble metal catalyst.

2. The process of claim 1, wherein the noble metal catalyst is recirculated to the reactive distillation column.

3. The process of claim 1, wherein the noble metal catalyst is present as a solution in an ionic liquid.

4. The process of claim 2, wherein the noble metal catalyst is present as a solution in an ionic liquid.

5. The process of claim 1, wherein the noble metal of the noble metal catalyst is selected from the group consisting of platinum, iridium, and mixtures thereof.

6. The process of claim 2, wherein the noble metal of the noble metal catalyst is selected from the group consisting of platinum, iridium, and mixtures thereof.

7. The process of claim 3, wherein the noble metal of the noble metal catalyst is selected from the group consisting of platinum, iridium, and mixtures thereof.

8. The process of claim 4, wherein the noble metal of the noble metal catalyst is selected from the group consisting of platinum, iridium, and mixtures thereof.

9. The process of claim 1, wherein allyl chloride is used as an alkene of the general formula (III).

10. The process of claim 2, wherein allyl chloride is used as an alkene of the general formula (III).

11. The process of claim 3, wherein allyl chloride is used as an alkene of the general formula (III).

12. The process of claim 5, wherein allyl chloride is used as an alkene of the general formula (III).
